(19) United States
(12) Patent Application Publication
(10) Pub. No.: US 2008/0231722 A1
(43) Pub. Date: Sep. 25, 2008

(54) System And Method For Image Capture And Distribution

(76) Inventor: Benjamin Whitehouse, Wilmette, IL (US)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(21) Appl. No.: 12/045,118

(22) Filed: Mar. 10, 2008

Related U.S. Application Data
(60) Provisional application No. 60/919,762, filed on Mar. 23, 2007.

(51) Int. Cl. H04N 5/225

(52) U.S. Cl. 348/222.1; 348/E05.024

(57) ABSTRACT

A system and method for capture, storage and display of a video image are disclosed. The system and method involve camera-based capture of images on an independent data storage medium for a first period of time. Thereafter, images are simultaneously captured on the independent data storage medium and a digital storage card associated with the camera for a second period of time. Images are then captured only on the independent data storage medium. The captured images are combined onto a single data storage medium and a program is provided to access and display such images in a desired sequence. High quality images of extended duration, e.g., twenty four hours, may thus be captured and displayed in a continuous, uninterrupted manner.

### CROSS-REFERENCE TO RELATED APPLICATION

The present application claims the benefit of a co-pending, provisional patent application entitled “System and Method For Image Capture and Distribution,” filed on Mar. 23, 2007 and assigned Ser. No. 60/919,762. The entire content of the foregoing provisional patent application is incorporated herein by reference.

### BACKGROUND

1. Technical Field

The present disclosure is directed to systems and methods for image capture and distribution and, more particularly, to systems and methods for capturing images over an extended period, storing such extended-period images in electronic form, and distributing such extended-period images for display and viewing at desired locations.

2. Background Art

The collection and distribution of images, e.g., video images, photographic images, and the like, is becoming increasingly prevalent. With the advent of image distribution channels, such as YouTube (http://www.youtube.com), individuals and small groups are increasingly participating in the capture and distribution of image-based compositions. Beyond such participatory web-based distribution channels, many websites host images of potential interest to web-users. For example, traffic cams are deployed in many metropolitan areas and offer real-time or near real-time access to traffic-related images/video. In a further example, National Geographic offers live cam images from remote locations, e.g., Botswana, that generally capture wild life-based images (http://www9.nationalgeographic.com/ngm/wildcamafrica/).

The quality of video images can vary widely. Recently, the broadcasting industry has begun distributing high-definition television (HDTV) images. HDTV involves digital television broadcasts with a significantly higher resolution than traditional formats (e.g., NTSC, SECAM, PAL). While some early analog HDTV formats were broadcast in Europe and Japan, HDTV is usually broadcast digitally, because digital television (DTV) broadcasting requires much less bandwidth. Current HDTV standards are defined by the International Telecommunication Union (ITU-R BT.709) as 1080 active interlace or progressive scan lines, or 720 progressive scan lines, using a 16:9 aspect ratio. By 2009, all U.S. television broadcasts will be exclusively digital by act of Congress. While HDTV offers significantly better quality images as compared to conventional broadcast standard, it is noted that 35 mm and 70 mm film projectors used in theaters offer the highest resolution and best viewing quality on very large screens.

Generally, the optimum format for a broadcast depends on the type of media used for the recording and the characteristics of the content. The field and frame rate should match the source, as should the resolution. On the other hand, a very high resolution source may require more bandwidth than is available in order to be transmitted without loss of fidelity. Photographic film destined for theater-based display typically has a high resolution and is photographed at 24 frames per second. Non-cinematic HDTV video recordings are typically recorded in either 720p or 1080i format. The “i” stands for “interlaced” and the “p” stands for “progressive”. The 720p format is frequently used with Internet distribution of HD video because computer monitors are progressive and most graphics cards do a poor job of de-interlacing video in real time. Video in 720p format also has lower storage and decoding requirements than 1080i or 1080p. For capture of HDTV images on disc, two optical disc standards, Blu-ray disc (BD) and HD DVD, may be employed. Thus, current HDTV sources include terrestrial broadcast, direct broadcast satellite, digital cable, high definition discs (BD and HD DVD), Internet downloads and the latest generation of games consoles.

HDTV broadcast transmissions can be recorded to D-VHS (Data-VHS), W-VHS (analog only), to a HDTV-capable digital video recorder (for example, a high-definition digital video recorder available from DirectTV, a set-top box available from SkyHD, and a Series 3 recorder available from TiVo),or a HDTV-ready HTPC. The massive amount of data storage required to archive uncompressed streams make it unlikely that an uncompressed storage option will appear in the consumer market anytime soon. MPEG-2 compression of an uncompressed digital HDTV signal is also prohibitively expensive for the consumer market.

While the capture, storage and display of high quality images has experienced significant technical advances in recent years, significant challenges remain. In particular, current technologies have not yielded systems and methods for capturing, storing and distributing high quality images that are captured in a continuous manner over extended periods. These and other needs are satisfied by the systems and methods of the present disclosure.

### SUMMARY

The present disclosure provides an advantageous system and method for capturing, storing and distributing high quality images that are captured in a continuous manner over an extended period. As used herein, the term “images” may include audio capture as well. The disclosed systems and methods are particularly adapted to capture images of artistic quality, e.g., images captured in natural settings or that otherwise reflect and/or embody artistic compositions. Thus, for example, images may be captured in natural settings, e.g., forest settings, meadow settings, mountainous settings, ocean/waterfront settings, and the like. According to exemplary embodiments of the present disclosure, video images are captured over extended periods, e.g., hours that can extend to a full twenty four hour period and beyond, without change in camera location.

The images associated with the present disclosure are generally captured in a remote location, i.e., a location that is remote from typical power supplies and/or data storage infrastructure. To ensure a high quality display image, the images are generally captured so as to support HDTV-quality display thereof. In order to support HDTV quality images, the disclosed systems and methods contemplate remote location of an appropriate data storage system, i.e., a data storage system that is capable of receiving and storing the large data streams associated with data capture of HDTV quality over an extended period, e.g., for as long as twenty four hours or more.

According to exemplary embodiments of the present disclosure, the following steps are employed to capture, store and distribute high quality video images:
1. Identify composition for image capture, e.g., natural or man-made environment, or a combination thereof.
2. Position image capture equipment at requisite location to capture desired image, including camera with at least one digital storage card, independent data storage medium, and laptop computer with image recording software.
3. Record image to independent data storage medium for a first period of time that approaches, but does not exceed, a predetermined time limit for image capture in a single capture session.
4. Simultaneously record image to independent data storage medium and to digital storage card associated with camera.
5. End first data capture to independent data storage medium.
6. Initiate second data capture session on independent data storage medium and continue image capture in such second data capture session, while discontinuing image capture on the digital storage card associated with the camera.
7. Repeat steps 3-5 until desired image capture period is achieved.
8. Transfer the images captured on the digital storage card to the independent data storage medium (or otherwise combine the storage locations of all captured images onto a single storage device).
9. Create program to effect retrieval and display of images from independent data storage medium.
10. Display continuous, high quality image on a display screen from the independent data storage medium (or other single storage device) for period up to the full period of image capture.

Exemplary embodiments of the disclosed systems and methods offer many advantages relative to prior art image capture, storage and distribution techniques. For example, the disclosed systems and methods permit high quality images, e.g., images that meet the HDTV standard, from a variety of locations over extended periods, e.g., as long as twenty four hours and longer. The high quality images may be displayed in a continuous, uninterrupted fashion from a single data storage medium, such that the captured image may be distributed and viewed by a plurality of individuals in a manner and of a quality commensurate with the live viewing. The disclosed systems and methods overcome equipment-related limitations by coordinating image capture to an independent storage medium and a digital storage card, so as to capture an uninterrupted image capture feed using a single camera.

Additional advantages features, functions and benefits of the disclosed systems and methods will be apparent from the detailed description which follows.

### BRIEF DESCRIPTION OF THE FIGURES

To assist those of skill in the art in making and using the disclosed systems and methods, reference is made to the accompanying figures, wherein:

FIG. 1 is an flowchart of an exemplary method for image capture, storage and display according to the present disclosure.

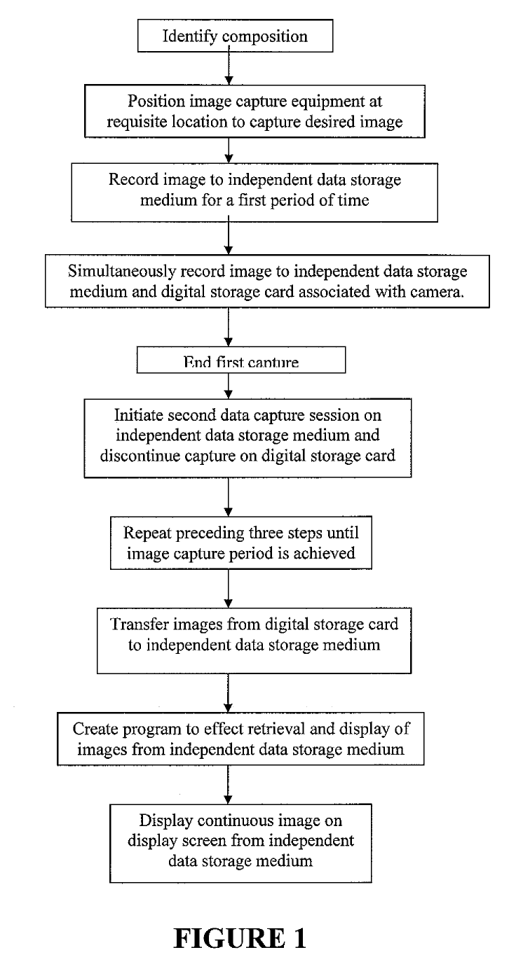

### DESCRIPTION OF EXEMPLARY EMBODIMENT(S)

The disclosed system and method facilitates capture, storage and distribution of high quality images that are captured in a continuous manner over an extended period. As used herein, the term “images” may include audio capture as well. Processing of the captured images permits distribution thereof and advantageous viewing of high quality, uninterrupted scenes that were captured using a single camera. Although the captured images are susceptible to many advantage uses, exemplary viewing options include residential, commercial and/or governmental display of captured images, e.g., as a dynamic artistic composition. Indeed, previous investments in static artistic renderings (e.g., paintings or photographs) may be superseded by a high quality, dynamic image that can be varied on a periodic basis. Display in such residential, commercial and/or governmental setting may be achieved on a high quality display screen, e.g., a plasma screen of large display area, that is fed by a single data storage medium, e.g., a RAID storage device or the like.

In exemplary embodiments of the present disclosure, selection of the setting or subject of the image capture, i.e., the composition, contributes to the desirability of the image that is ultimately captured and distributed. Thus, for example, the disclosed systems and methods are particularly adapted for capturing images of artistic quality, e.g., images captured in natural settings or that otherwise reflect and/or embody artistic compositions. Thus, for example, images may be captured in natural settings, e.g., forest settings, meadow settings, mountainous settings, ocean/waterfront settings, and the like. It is further contemplated that settings involving man-made structures and/or activities may also provide desirable compositions, e.g., significant buildings, bridges, ports and the like.

According to exemplary embodiments of the present disclosure, video images are captured over extended periods, e.g., hours that can extend to a full twenty four hour period and beyond, using a single camera and without change in camera location. The images associated with the present disclosure are frequently captured in a remote location, i.e., a location that is remote from typical power supplies and/or data storage infrastructure. In such circumstances, it is generally necessary to augment the image capture equipment otherwise required with a power generator and fuel therefore. Preferably, any equipment associated with image capture operates at a low noise level, and appropriate noise and vibrational shielding/distance may be employed to minimize the impact thereof on the quality of the captured image.

To ensure a high quality display image, the images are generally captured so as to support HDTV-quality display thereof. In order to support HDTV quality images, the disclosed systems and methods contemplate remote location of an appropriate data storage system, i.e., a data storage system that is capable of receiving and storing the large data streams associated with data capture of HDTV quality over an extended period, e.g., for as long as twenty four hours or more. In exemplary embodiments of the present disclosure, a conventional RAID storage device is employed for data collection, subject to the limitations discussed herein. Alternative data storage equipment may be employed without departing from the spirit or scope of the present disclosure, provided such data storage equipment is effective to store the significant amounts of data associated with the image capture contemplated herein.

According to exemplary embodiments of the present disclosure, the following steps are employed to capture, store and distribute high quality video images:
1. Identify composition for image capture, e.g., natural or man-made environment, or a combination thereof. The present disclosure may be employed with respect to any potential composition, although artistically pleasing compositions will generally be of greater interest to potential viewers.
2. Position image capture equipment at requisite location to capture desired image, including camera with at least one digital storage card, independent data storage medium, and laptop computer with image recording software. As noted previously, it may be necessary or desirable to include a power generator to support the electronic equipment associated with the image capture process. Additional auxiliary equipment and/or accessories may be desirable and/or useful, e.g., a tent or other temporary enclosure to shield the data capture and data storage equipment (as well as the photographer and any associated staff), e.g., to provide protection from the elements. In an exemplary embodiment of the present disclosure, a tent/enclosure is positioned at a desired location relative to the selected “composition” and the camera is positioned within the tent/enclosure such that the lens captures the desired through an opening in the tent/enclosure.
   The power source, e.g., a quiet generator, may be located at a distance from the camera so as to be inaudible to the microphone. If a power supply is available at the filming site, the requisite equipment is plugged into the associated power socket(s). If the power source is a generator, sufficient gas and gas-filling equipment for replenishment of the generator during operation is included in the equipment list. Of note, it is generally required that the generator will be required to run continuously for the entire filming period, e.g., 24 hours. The electronic equipment is typically protected from power surges by a surge protector.
   The camera is typically a high definition digital camera that includes a microphone. The camera is typically in electronic communication with a computer/processor, e.g., a laptop computer, and an independent data storage medium of high capacity, e.g., a RAID storage device. The computer/laptop typically includes, inter alia, software that facilitates image capture and recording, e.g., Final Cut Pro software. One or more digital storage cards are generally inserted into the camera to augment the storage operations of the RAID, as will be described in greater detail below.
3. Record image to independent data storage medium (e.g., RAID device) for a first period of time that approaches, but does not exceed, a predetermined time limit for image capture in a single capture session. In exemplary embodiments of the disclosed system and method, images are recorded on the independent data storage medium for a first period of time that is about 5-6 hours due to limitations on the duration of a single capture imposed by the imaging software.
4. As expiration of the first period of time approaches, images are simultaneously recorded from the camera on the independent data storage medium and on the digital storage card associated with camera. This simultaneous recordation to two locations permits the operator to close one capture session on the RAID and open another capture session without loss of any images. The images that are simultaneously routed to the digital storage card may be termed ‘changeover clips’ that will be necessary to ultimately deliver an uninterrupted, continuous image to a future viewer.
5. End first data capture to independent data storage medium, thereby establishing a defined data file containing data capture on the independent data storage medium.
6. Initiate second data capture session on independent data storage medium and continue image capture in such second data capture session, while discontinuing image capture on the digital storage card associated with the camera. Thus, the “changeover clips” are of relatively short duration, particularly when viewed in the overall context of an image capture that may be on the order of twenty four hours.
7. Repeat steps 3-5 until desired image capture period is achieved. The process is generally repeated every 5-6 hours until the full image is captured, e.g., over the course of 24 hours. Throughout the image capture period, e.g., the entire 24 hours, the camera operator(s) are called upon to operate the camera so as to optimize the image capture, e.g., by making adjustments for light conditions and the like.
8. Once the image capture is complete, the captured images are transferred to a single data storage location. Thus, data on the digital storage card, i.e., the “changeover clips,” may be transferred to the independent data storage medium, i.e., the RAID. Alternatively, both the images associated with the changeover clips and the data initially stored on the independent data storage medium, e.g., the RAID device, may be transferred to a third data storage repository, e.g., a new RAID or another storage medium.
   Once the captured data is co-located on a desired storage medium, a program is generally created on a computer, e.g., using Apple QuickTime, that makes it possible to deliver the large files that were originally collected/stored on the RAID and the ‘missing’ portion of the ‘changeover files” in synched and proper order, such that the entire 24 hour image collection period is delivered uninterrupted and seamlessly.
   According to exemplary embodiments of the disclosed systems and methods, combination of the captured images on disc(s) (e.g., Blu-ray and/or HD DVD discs) may provide a desirable approach for data storage and distribution. However, current technology allows a single disc to store only about five hours of high definition media; accordingly, to deliver extended periods of image capture, e.g., on the order of 24 hours, would require multiple discs and, with current technology, image display from multiple discs would disadvantageously translate to periodic display interruptions as one disc ends and another begins. Such difficulties may be minimized and potentially overcome through a carousel feed or other disc delivery technology that overcomes potential interruptions associated with disc-to-disc transitions.
9. Create program to effect retrieval and display of images from independent data storage medium. In exemplary embodiments of the present disclosure, the data files are combined/stored on a single data storage device with distinct file names. A customized program is created that points to the individual files/file names in a desired order, such that the files are opened and displayed in a desired sequence to provide a continuous image display.
   For example, the distinct image files may be advantageously stored on a RAID. A customized QuickTime file may be created to point to the distinct image files in a desired sequence. The QuickTime file may be accessed and run using an appropriate control unit/processor, e.g., a Mac Mini processor available from Apple Computer. The Mac Mini may be programmed for playback of a QuickTime file, e.g., using a Front Row software that is generally operative on a Mac Mini unit.
10. Display continuous, high quality image on a display screen from an independent data storage medium (or other single storage device) for period up to the full period of image capture, e.g., twenty four hours or the like. Image display is advantageously achieved on a high quality screen of a desired dimension to give effect to the captured composition, e.g., a plasma screen display. In exemplary embodiments of the present disclosure, the captured images (i.e., a combination of the images stored in the field on the RAID and the changeover clips) are fed directly from a single data storage medium, e.g., a RAID, and a computer, e.g., a Mac Mini, that are in communication with the display screen by accessing a customized QuickTime file that is accessed and played back by Front Row software loaded onto the Mac Mini unit.

As noted previously, exemplary embodiments of the disclosed systems and methods offer many advantages relative to prior art image capture, storage and distribution techniques. For example, the disclosed systems and methods permit high quality images, e.g., images that meet the HDTV standard, from a variety of locations over extended periods, e.g., as long as twenty four hours and longer. The high quality images may be displayed in a continuous, uninterrupted fashion from a single data storage medium, such that the captured image may be distributed and viewed by a plurality of individuals in a manner and of a quality commensurate with the live viewing. The disclosed systems and methods overcome equipment-related limitations by coordinating image capture to an independent storage medium and a digital storage card, so as to capture an uninterrupted image capture feed using a single camera.

Although the systems and methods of the present disclosure have been described with reference to exemplary embodiments and implementations thereof, the present disclosure is not limited to or by such exemplary embodiments/implementations. Rather, the systems and methods of the present disclosure are susceptible to many variations, modifications and enhancements without departing from either the spirit or the scope hereof. The present disclosure expressly encompasses all such variations, modifications and enhancements herein.

1. A system for capturing and displaying a video image, comprising:
a. a camera for capture of a video image, the camera in communication with at least one digital storage card for receipt of at least one discrete data capture file;
b. at least one independent data storage medium in communication with the camera for receipt of at least one additional data capture file;
c. a processor programmed for sequential display of the at least one discrete data capture file and the at least one additional data capture file in a desired sequence.

2. A system according to claim 1, wherein the camera is adapted to capture the video image in an HDTV quality format.

3. A system according to claim 1, wherein the camera is in communication with a power source.

4. A system according to claim 3, wherein the power source is selected from the group consisting of a power generator and a power outlet.

5. A system according to claim 1, wherein the camera is adapted to simultaneously feed data to the at least one digital storage card and the at least one independent data storage medium.

6. A system according to claim 1, wherein the at least one discrete data capture file and the at least one additional data capture file are combined onto a single independent data storage medium.

7. A system according to claim 6, wherein the at least one discrete data capture file and the at least one additional data capture file are combined onto a RAID.

8. A system according to claim 1, wherein the camera feeds data to the at least one independent digital storage medium for a first period of time, simultaneously feeds data to the at least one independent digital storage medium and the at least one digital storage card for a second period of time, and then continues its feed to the at least one independent storage medium, but discontinues continued feed to the at least one digital storage card for a third period of time.

9. A system according to claim 8, wherein the recited steps are repeated for as long as the camera captures the video image.

10. A system according to claim 1, further comprising displaying the at least one discrete data capture file and the at least one additional data capture file on a video screen.

11. A method for capturing and displaying a video image, comprising:
a. positioning a video camera for capture of a desired image;
b. recording an image from the camera onto an independent data storage medium in communication with the camera for a first period of time;
c. simultaneously recording an image from the camera onto the independent data storage medium and a digital storage card associated with the camera for a second period of time;
d. continuing recordation of an image from the camera onto the independent data storage medium, while discontinuing storage on the digital storage card, for a second period of time;
e. combining the images captured during the first, second and third periods of time on a single data storage medium.

12. A method according to claim 11, further comprising:
f. providing a processor that is programmed to access and display the images captured in the first, second and third periods of time in a desired sequence.

13. A method according to claim 12, further comprising:
g. displaying the images on a display screen.

14. A method according to claim 11, wherein the image captured by the digital storage card during the second period of time is combined with the images captured during the first and third periods of time on the single data storage medium.

15. A method according to claim 11, wherein steps (b)-(d) are repeated until the desired image is captured.
